(19) United States
(12) Patent Application Publication
(10) Pub. No.: US 2016/0334530 A1
(43) Pub. Date: Nov. 17, 2016

(54) METHOD AND SYSTEM FOR PROCESSING ACOUSTIC WAVEFORMS

(71) Applicant: Denis Evgenievich SYRESIN, Dubna, Moskovskayaobl (RU)

(72) Inventors: Denis Evgenievich Syresin, Kanagawa-ken (JP); Timur Vyacheslavovich Zharnikov, Moscow (RU); Masafumi Fukuhara, Kanagawa (JP); Takeshi Endo, Kanagawa-ken (JP); Hiroaki Yamamoto, Kanagawa-Ken (JP)

(21) Appl. No.: 15/109,416

(22) PCT Filed: Dec. 30, 2013
(86) PCT No.: PCT/RU2013/001198

§ 371 Date: Jun. 30, 2016

(51) Int. Cl. G01V 1/48

(52) U.S. Cl. CPC G01V 1/48

(57) ABSTRACT

Method for processing acoustic waveforms comprises acquiring acoustic waveforms in a borehole traversing a subterranean formation and transforming at least a portion of the acoustic waveforms to produce frequency domain signals. Then model dispersion curves, modes spectrum or waveforms are generated based on an anisotropic borehole-formation model having a set of anisotropic and geometrical borehole-formation parameters and by specifying governing equations and computational mesh based functional basis. The frequency-domain signals are back-propagating using the model dispersion curves to correct dispersiveness of the signals and coherence of the back-propagated signals is calculated. Alternatively the difference between the measured and the model dispersion curves is determined. Model parameters are iteratively adjusted until the coherence reaches a maximum or exceeds a selected value, or alternatively until the difference between the measured and the model dispersion curves becomes minimal or is reduced to below a selected value. Then at least a portion of the set of anisotropic and geometrical borehole-formation parameters is obtained.

### FIELD OF THE INVENTION

The invention relates generally to acoustic well logging. More particularly, this invention relates to acoustic well logging techniques useful in determining formation properties.

### BACKGROUND OF THE INVENTION

In acoustic logging, a tool is lowered into a borehole and acoustic energy is transmitted from a source into the borehole and the formation. The acoustic waves that travel in the formation are then detected with an array of receivers. These waves are dispersive in nature, i.e. the phase slowness is a function of frequency. This function characterizes the wave and is referred to as a dispersion curve or mode's spectrum. A challenge for processing acoustic data is how to correctly handle the dispersion effect of the waveform data.

Important step in processing acoustic logging data is dispersion or modes' spectral analysis, that is, its optimal decomposition in limited number of modes in frequency-wavenumber domain, for example, based on Prony's method (Ekstrom, M. E. “Dispersion estimation from borehole acoustic arrays using a modified matrix pencil algorithm”, 29th Asilomar Conference on Signals, Systems, and Computers, California, 1995). That is, it tries to find best fit of the signal by a limited sum of complex exponents. Its results are further used to extract information about elastic properties of formation. One of the ways to do it is to compare measured dispersion curves with a reference dispersion curve calculated under certain assumptions.

Current reference dispersion curves are calculated in several ways. For isotropic and VTI (vertically transversely isotropic) formations an analytical solution for radially layered medium is available and can be used to calculate dispersion curves by mode-search type of routines (B. K. Sinha, S. Asvadurov, “Dispersion and radial depth of investigation of borehole modes”, Geophysical Prospecting, v. 52, p. 271, 2004). The limitation is that they require a circular borehole and are not available for anisotropic or irregular formations. Direct 3D modeling of wavefield can be employed (P. F. Daley, F. Hron, “Reflection and transmission coefficients for transversely isotropic media”, Bulletin of the Seismological Society of America, v. 67, p. 661 1977; H. D. Leslie, C. J. Randall, “Multipole sources in boreholes penetrating anisotropic formations: numerical and experimental results”, JASA, v. 91, p.12, 1992; R. K. Mallan et al., “Simulation of borehole sonic waveforms in dipping, anisotropic and invaded formations”, Geophysics, v. 76, p. E127, 2011; M. Charara et al., “3D spectral element method simulation of sonic logging in anisotropic viscoelastic media”, SEG Exp. Abs., v. 30, p.432, 2011). The problem of these methods is heavy computational requirements. A dispersion curve and spectrum of a guided wave involves numerous model parameters. Even in the simplest case of a fluid-filled borehole without a tool, six parameters are needed to calculate the dispersion curve (i.e., a borehole size, formation P- and S-velocities and density, and fluid velocity and density). In an actual logging environment, other unknown parameters, such as changing fluid property, tool or casing off-centering, formation alteration, borehole irregularity, etc., also alter the dispersion characteristics. Therefore a need remains for fast and efficient calculation of dispersion curves and modes' spectra with allowance for arbitrary anisotropy, formation radial and azimuthal inhomogeneity (including radial profiling, borehole irregularity and ovality and stress-induced anisotropy, etc.) and tool or layers eccentricity.

In principle, possible main steps of sonic logging and data processing are well known and documented, such as firing acoustic signal with the transmitter and obtaining waveforms at receivers, extracting low frequency asymptote of the dispersive signal, comparing with the model dispersion curves, etc. However, practical processing, which includes the step of comparing the measured data with the modeled dispersion curves is currently limited to isotropic or TIV formations and borehole with circular cross-sections. Performing this step for other types of anisotropic formations (general anisotropy) or borehole with non-circular and nonconcentric cross section is impractical because either the accuracy is not always sufficient or controllable (perturbation theory approach, etc.) or the computation time is prohibitively large (full 3D wavefield modeling, etc.). The proposed invention rectifies this deficiency and demonstrates the algorithm to solve this problem both accurately and in time, which is acceptable for practical purposes. Therefore, it allows the processing to be done for the completely new class of rock formations—arbitrary anisotropy with spatial variation; and more complex geometry of boreholes including tool or casing eccentricity, borehole ovality and irregularity, etc. At the moment, it is not possible to do by any other means with acceptable accuracy and speed. As a result, it is drastic change in the capabilities of the existing process and makes for the whole new process. The capabilities include possibility of taking into account and treating formations of arbitrary anisotropy (arbitrary symmetry class), arbitrary radial and azimuthal variation of formation physical properties, logging tool and/or casing eccentricity, borehole with irregular or complicated geometry of cross-section. Axial variation of properties can be, in principle, also taken into account. This is completely new capability. Computational efficiency allows the proposed invention to be used for the well-site modeling of dispersion curves, modes' spectra and waveforms for general anisotropic formations, which is also new. The requirements for the computational power are drastically reduced (orders of magnitude both in time and hardware (memory, number of CPUs, etc.) requirements). For well-site or further processing significant improvement of computational efficiency implies increased turnaround time of data processing, interpretation, answer products, etc: This capability is new with respect to the currently available approaches.

### SUMMARY OF THE INVENTION

In accordance with one embodiment of the invention, a method for processing acoustic waveforms comprises acquiring acoustic waveforms in a borehole traversing a subterranean formation and transforming at least a portion of the acoustic waveforms to produce frequency domain signals. Then model dispersion curves and/or modes' spectrum are generated based on an anisotropic borehole-formation model having a set of anisotropic borehole-formation parameters by specifying governing equations and 2D mesh accounting for borehole cross section geometry is constructed. Representation of the governing equations' and boundary and interface conditions in some local or global functional basis corresponding to constructed mesh is found and the resulting set of equations is discretized according to truncated or infinite functional basis. The spectrum is found by solving the generalized eigenvalue problem or homogeneous or inhomogeneous linear matrix equation. The frequency-domain signals are back propagated using the model dispersion curves to correct dispersiveness of the signals, coherence of the back-propagated signals is calculated and model parameters are iteratively adjusted until the coherence reaches a maximum or exceeds a selected value. At least a portion of the set of elastic or geometrical borehole-formation parameters is outputted.

A method for processing acoustic waveforms according to another embodiment of the invention comprises acquiring acoustic waveforms in a borehole traversing a subterranean formation and generating measured dispersion curves from the acquired waveforms. Model dispersion curves and/or modes' spectrum are generated based on an anisotropic borehole-formation model having a set of anisotropic borehole-formation parameters by specifying governing equations. 2D mesh accounting for borehole cross section geometry is constructed and representation of the governing equations' and boundary and interface conditions in some local or global functional basis corresponding to constructed mesh is found. The resulting set of equations is discretized according to truncated or infinite functional basis. The spectrum is found by solving the generalized eigenvalue problem or homogeneous or inhomogeneous linear matrix equation and a difference between the measured and the model dispersion curves is determined. Model parameters are iteratively adjusted until difference between the measured and the model dispersion curves becomes minimal or is reduced below a selected value and at least a portion of the set of elastic or geometrical borehole-formation parameters is outputted.

System for processing sonic logging waveforms and borehole spectra comprises means for exciting and measuring acoustic signals in a borehole, means for digitizing acoustic signals from plurality of receivers data into acoustic waveforms, means for processing the acoustic waveforms and generating dispersion curves and modes' spectra, computational means for generating model reference dispersion curves, waveforms, spectra, means for determining a difference between the model dispersion curves, waveforms, spectra and measured dispersion curves, waveforms, spectra, means iteratively adjusting model parameters until the difference between the measured and the model dispersion curves, waveforms or spectra becomes minimal or is reduced to below a selected value and means for outputting and/or storing at least a portion of the set of elastic or geometrical borehole-formation parameters.

The system may further comprise means for adjusting acoustic tool properties according to logging conditions (e.g. transducer frequency band) and means for optimizing processing software parameters to improve the quality of the results (e.g. applied filters' frequency band).

### BRIEF DESCRIPTION OF THE DRAWINGS

FIG. 1 is a schematic description of wireline-logging system with an acoustical logging tool disposed in borehole and controlling and processing means outside.

FIG. 2 is a flow chart of a method of acoustic waveforms processing in accordance with the invention.

### DETAILED DESCRIPTION OF THE INVENTION

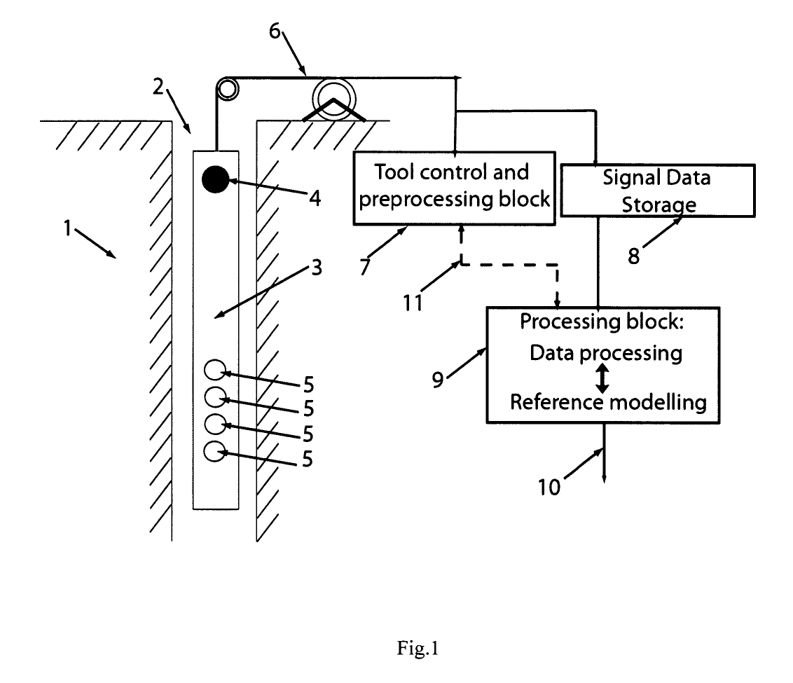

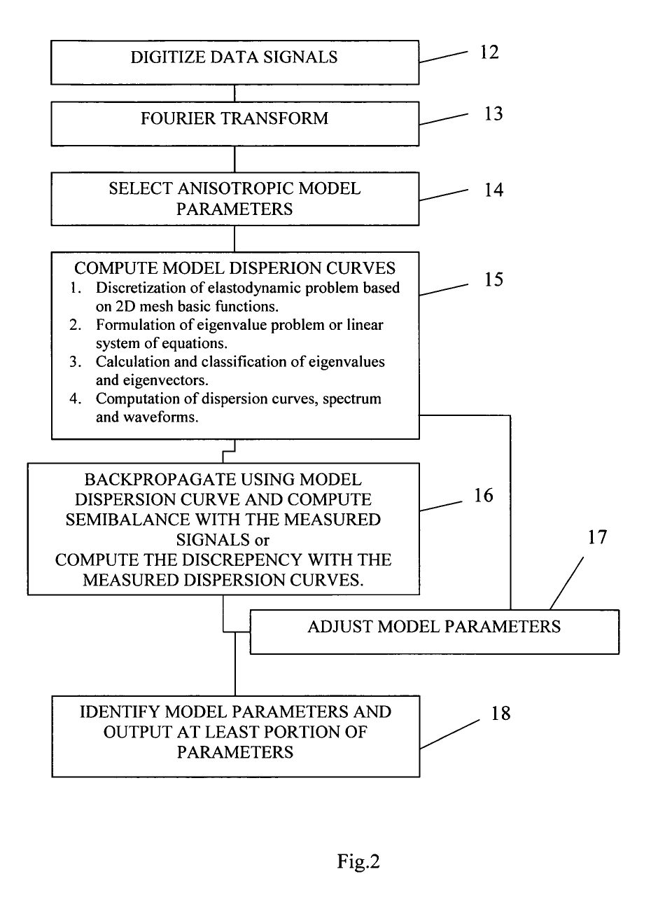

FIG. 1 shows the general illustration of the measurement by logging tool in a borehole and processing outside it. To study physical properties of a subterranean formation 1 one may drill a borehole 2, which traverses the formation 1. The formation may be inhomogeneous and anisotropic, while the borehole can have a noncircular shape of cross section. In acoustic logging, a tool 3 is lowered into the borehole and acoustic energy is transmitted from transducers 4 into the borehole and the formation. The acoustic waves that travel in the formation are then detected with an array of receivers 5. To push or pull the tool inside the formation 1 and to control its depth a logging/data cable 6 is often used. Through this cable the information about the acoustic signals, measured by the array of receivers 5 can be acquired. This data may flow to a tool control block 7 or to a data storage 8 device. The main goal of the block 7 is to control the tool and environment in the borehole 2 (e.g. tool depth). This block 7 may be also used for data preprocessing in order to control the data quality and to adjust some logging parameters (e.g. speed of movement, frequency band, etc.). The data storage device 8 records and keeps the data about the measured signals and logging conditions. This data goes to and is processed by a processing block 9. It makes full or partial processing of the input data and provides the calculation of waveforms, dispersion curves and signal spectra, according to the input data. The reference dispersion curves, waveforms and spectra are modelled inside the processing block 9, as well. Using the procedure explained in detail below and described schematically on FIG. 2 the input and generated reference data are compared iteratively inside this block. As a result at least a portion of the set of elastic or geometrical borehole-formation parameters is outputted through a channel 10. According to the difference between measured and reference data the decision about adjusting the logging conditions may be formulated inside the processing block 9 and delivered to the control block 7 through a feedback channel 11.

Acoustic data acquired with the logging tool 3 are waveforms received by the receivers. These waveforms include a large amount of data, which would need to be analyzed with an appropriate method to derive information related to formation properties.

FIG. 2 shows a schematic of a process in accordance with one embodiment of the invention for inverting borehole-formation parameters from acoustic waveforms. As shown, the acoustic waveforms are digitized (step 12 on FIG. 2) and converted into the frequency domain by a suitable transformation (e.g., Fourier Transform (FT) or Fast Fourier Transform FFT)—step 13 on FIG. 2. According to steps 14 and 15 model dispersion curves and modes' spectra are generated based on an anisotropic complex geometry borehole-formation model having a set of anisotropic borehole-formation parameters by specifying governing equations, introducing 2D mesh (e.g. element based), finding the representation of the governing equations' and boundary and interface conditions in functional basis corresponding to constructed mesh, discretizing the resulting set of equations according to functional basis, finding the spectrum, dispersion curves or waveforms by solving the generalized eigenvalue problem or homogeneous or inhomogeneous linear matrix equation;

Then, the frequency domain signals are back propagated using model dispersion curves, modes' spectrum or waveforms to correct for dispersiveness of the signals (step 16 on FIG. 2). The back propagation produces back-propagated waveforms, which are in the frequency domain.

Coherence of the back-propagated waveforms is then calculated. The processes of back propagation and computing coherence may be repeated iteratively by obtaining a new set of model dispersion curves that correspond to a different set of borehole-formation parameters (step 17 on FIG. 2). These processes are repeated until the coherence meets a selected criterion, such as reaching a maximum or exceeding a selected value. Then, the borehole-formation parameters are output (step 18 on FIG. 2).

Alternatively, measured dispersion curves can be found from acquired waveforms. The difference between the measured and the model dispersion curves can be determined (step 16 on FIG. 2) and iteration may be performed adjusting model parameters to produce the minimal difference between the measured and the model dispersion curves or reduce the difference between the measured and the model dispersion curves to below a selected value (step 17 on FIG. 2). The choice of model parameters depends on the particular problem to be solved. For example, if the target is to evaluate elastic moduli of a formation assuming it to be homogeneous tilted transversely isotropic (TTI) one, possible parameters are 5 elastic moduli (C11, C13, C33, C44, C66) and relative dip angle θ. Bulk modulus of a drilling mud can be either taken as known approximately or added to the list of model parameters depending on the processing algorithm. The densities are usually obtained from other measurements.

Then, some or all of the borehole-formation parameters corresponding to the model dispersion curves that produce the minimal difference between the measured and the model dispersion curves are output to provide information on formation properties (step 18 on FIG. 2).

An example of one of the embodiments relates to determination of formation elastic moduli, for instance, 5 TTI parameters which are required for geomechanical applications like determination of well stability, etc. Formation density can be estimated from gamma logs and mud density can be measured or guessed with reasonable accuracy. If it necessary borehole geometry and irregularity can be found from borehole diameter measurement by caliper. Such geometry provides the approximate geometry model for mesh constructing. Similarly, bulk modulus of the drilling mud can be either guessed or, in principle, measured in situ. Then the attenuation in the mud is disregarded and formation is assumed to be homogeneous TTI one. Therefore, one arrives at the problem of determination one parameter of the TTI model (e.g. elastic moduli (C11, C13, C33, C55, C66) from the sonic logging measurement. To address this problem, the invention proposed in this patent is embodied as described below.

Sonic waveforms in a borehole are recorded as dependent on azimuth and vertical coordinate by a typical logging tool. The recorded signals are digitized.

Dispersion curves are estimated from the measured data by any known method (see, for example, Ekstrom, M. E. “Dispersion estimation from borehole acoustic arrays using a modified matrix pencil algorithm”, 29th Asilomar Conference on Signals, Systems, and Computers, California, 1995).

Then the initial set of elastic parameters is defined. For example, one can start with the isotropic model whose moduli λ and μ are estimated from the speeds of shear and compressional waves, recorded by the logging tool.

λ=ρ(Vₚ²−2Vₛ²), μ=ρVₛ²

where Vₚ is a P-wave velocity, Vₛ is a shear-wave velocity, ρ is the density.

Then dispersion curves of borehole modes recorded by the tool (e.g. Stoneley, pseudo Rayleigh, dipole flexural, quadrupole modes, etc.) are modeled. The modeling process starts with specifying governing general elastodynamic equations:

−ρω²uᵢ=∂ⱼσᵢⱼ

σᵢⱼ=cᵢⱼₖₗεₖₗ

According to the geometry of borehole cross section one generates two-dimensional computational mesh. This mesh describes the details of borehole cross section geometry and takes into account its irregularity, ovality, tool or internal layers (e.g. casing) eccentricity and more complex structures. The one of the possible solution is to present the cross-section as set of 2D finite elements (e.g. triangular, rectangular or curvilinear).

The matrix representation of the governing equations' operator (e.g. that of anisotropic elastodymanics, viscoelasticity, etc.) and operator of boundary and interface conditions (e.g. free surface, rigid, welded, slip, etc.) are found in some functional basis, corresponding to generated mesh. For example, for time harmonic cylindrical waves the basis is e^{i(kz-ωt)}Nⱼ(x, y) in Cartesian coordinates or e^{i(kz-ωt)}Nⱼ(r, θ) in cylindrical ones. For 2D finite-element mesh the matrix function Nⱼ(x, y) corresponds to shape function of j^{th} element.

Then the solution of general elastodynamic is expanded with respect to a set of basic functions. For example, the displacement vector in Cartesian coordinates at arbitrary point looks as follows:

$$\overline{u} ( x , y , z ) = {\sum }_{j = 1}^{∞} \int d k \int d ω {N}_{j} ( x , y ) {\overline{U}}^{j} {e}^{i ( kz - ω t )}$$

Here Ū^{j} are nodal weight coefficients for displacement vector.

Either frequency or wavenumber value can be fixed to reduce one dimension to eigenvalue problem with respect to the wavenumber or frequency in 2D (x, y) or (r, θ). For example, fix of wavenumber k* yields the following equation:

ū(x, y, k*)=∫dωNⱼ(x, y)Ū^{j}e^{i(k}*^{z-ωt)}

The resulting set of equations and boundary conditions and interface conditions can be discretized by applying the one of the variational techniques (e.g. by use of Euler-Lagrange formalism, Galerkin method, Virtual work principle or any other). As the set of basic functions is chosen to be finite or truncated, it results in the finite size matrix eigenvalue problem (no source) or linear matrix equation (with the source). As an eigenvalue one can choose the frequency, wavenumber, or any other value, which characterizes the spectrum of the borehole modes.

The spectrum is found by solving the generalized eigenvalue problem (no source) or the linear matrix equation (with the source). The eigenvalues and eigenfunctions are processed and classified by selecting those with physical meaning and those which correspond to the mode of interest. This is done using the properties and symmetries of the solutions. For example, dipole flexural can have maximum of coefficients of expansion at n=±1 (for cylindrical basic functions), etc.

The generated model dispersion curves, spectrum or waveforms are compared with the dispersion curves, spectrum or waveforms estimated form the measured data. If there is no difference, initial approximation is considered to be good and the formation parameters are found (C11=λ+2μ, C13=λ, C33=λ+2μ, C55=μ, C66=μ). Otherwise elastic moduli (C11, C13, C33, C55, C66) are adjusted and one goes back to step of modeling dispersion curves and/or borehole spectrum.

Modeling and comparison are repeated, until model dispersion curves, spectrum or waveforms are considered to match well with the experimental data. At this moment the elastic moduli, for which this match is observed, are considered to describe the formation.

Instead of elastic moduli, one can use the method described above to find geometrical parameter of borehole cross section, such as the intensity and direction of tool off-centering, intensity and direction of casing off-centering ovality of the borehole. To do this one need to use approximate geometry of the cross section, which can be, for example, estimated by mechanical tools (e.g. caliper).

Suggested method is reasonably fast and does not require heavy computational facilities, it works in reasonably wide range of parameters, is sufficiently accurate and robust.

Suggested method affects a number of applications, raising them to the new technology level (which is currently limited due to absence of borehole modes' dispersion curve computation algorithms for anisotropic formations and complex geometry boreholes, which are both accurate and computationally efficient). Such applications include, but are not limited to:

Obtaining model dispersion curve based on an anisotropic borehole-formation model (including arbitrary anisotropy; arbitrary radial and azimuthal inhomogeneity; arbitrary spatial inhomogeneity, arbitrary geometry of cross section) having a set of anisotropic borehole-formation parameters. The algorithm allows for fast and computationally efficient calculation of dispersion curves for waveguides (including boreholes) with allowance for arbitrary anisotropy, radial and azimuthal inhomogeneity of waveguide properties (including layering, radial profiling, borehole irregularity and stress-induced anisotropy, etc.) and tool and/or layers eccentricity.
Solution of inverse problem and extracting properties of formation, borehole geometry, or eccentricity by comparing measured dispersion curves with those modeled by the proposed method. It includes radial profiling for cased and open boreholes in anisotropic formation.
Survey parameter decision/optimization at wellsite or prior to the job.
Optimization of the survey parameters (e.g. transducer frequency band) according to logging conditions.
Optimization processing software parameters, e.g. applied filters' frequency band, to improve the quality of the results.
Estimation of mode contamination in complex borehole environments and vice versa evaluation of borehole parameters from mode contamination information.
Quality control of the results obtained in previous items.
Determination of elastic moduli. E.g. TTI parameters.
Determination of geometry peculiarities in borehole. E.g. non circular form or tool/casing eccentricity.
Check of and comparison of the modeled dispersion curves with the results of dispersion analysis of measured data.
The interpretation of sonic data. Determination of the elastic moduli, identification of local parameter variations and verification of the results.
Well development decisions. E.g. geomechanical applications like well stability, etc. Also for example for horizontal wells, gas shale wells, etc. For example, local variations of elastic moduli can be used to plan and improve completion decisions, geomechanical decisions, fracturing jobs design.

Possibly for LWD shear evaluation from monopole pseudo Rayleigh wave.

1. Method for processing acoustic waveforms comprising:
acquiring acoustic waveforms in a borehole traversing a subterranean formation,
transforming at least a portion of the acoustic waveforms to produce frequency-domain signals,
generating model dispersion curves, spectrum and waveforms based on an anisotropic borehole-formation model having a set of anisotropic borehole-formation parameters by specifying governing equations;
constructing the 2D mesh accounting for borehole cross section geometry;
finding representation of the governing equations' and boundary and interface conditions in functional basis, corresponding to introduced mesh;
discretizing the resulting set of equations according to functional basis;
solving the generalized eigenvalue problem or linear matrix equation,
back-propagating the frequency-domain signals using the model dispersion curves to correct dispersiveness of the signals,
calculating coherence of the back-propagated signals, iteratively adjusting model parameters until the coherence reaches a maximum or exceeds a selected value, and
outputting at least a portion of the set of elastic or geometrical borehole-formation parameters.

2. The method of claim 1 wherein the acoustic waveforms comprise signals from a Stoneley mode, a quasi-Rayleigh mode, a dipole mode, or a quadrupole mode.

3. The method of claim 1 wherein the acoustic waveforms are converted into the frequency domain signals by Fourier transforming or Fast Fourier Transforming.

4. The method of claim 1 wherein a finite-element, Galerkin type, (quasi) spectral-element, boundary-element, finite-difference or any other geometry based approximations can be used for the matrix representation.

5. The method of claim 1 wherein a frequency or a wavenumber value is fixed to reduce one dimension to eigenvalue problem with respect to the wavenumber, frequency or their functions in 2D (x, y) or (r, θ).

6. Method for processing acoustic waveforms comprising:
acquiring acoustic waveforms in a borehole traversing a subterranean formation,
generating measured dispersion curves and/or spectrum from the acquired waveforms,
generating model dispersion curves, spectrum and waveforms based on an anisotropic borehole-formation model having a set of anisotropic borehole-formation parameters by specifying governing equations;
constructing the 2D mesh accounting for borehole cross section geometry;
finding a the representation of the governing equations' and boundary and interface conditions in functional basis, corresponding to introduced mesh;
discretizing the resulting set of equations according to functional basis;
solving the generalized eigenvalue problem or linear matrix equation,
determining a difference between the measured and the model dispersion curves and/or spectrum,
iteratively adjusting model parameters until the difference between the measured and the model dispersion curves becomes minimal or is reduced to below a selected value, and
outputting at least a portion of the set of elastic or geometrical borehole-formation parameters.

7. The method of claim 6 wherein the acoustic waveforms comprise signals from a Stoneley mode, a quasi-Rayleigh mode, a dipole mode, or a quadrupole mode.

8. The method of claim 1 wherein a finite-element, Galerkin type, (quasi) spectral-element, boundary-element, finite-difference or any other geometry based approximations can be used for the matrix representation.

9. The method of claim 6 wherein a frequency or a wavenumber value is fixed to reduce one dimension to eigenvalue problem with respect to the wavenumber, frequency or their functions in 2D (x, y) or (r, θ).

10. System for processing sonic logging waveforms and borehole spectra comprising:
means for exciting and measuring acoustic signals in a borehole,
means for digitizing acoustic signals from plurality of receivers data into acoustic waveforms,
means for processing the acoustic waveforms and generating dispersion curves and modes' spectra,
computational means for generating model reference dispersion curves, waveforms, spectra,
means for determining a difference between the model dispersion curves, waveforms, spectra and measured dispersion curves, waveforms, spectra,
means iteratively adjusting model parameters until the difference between the measured and the model dispersion curves, waveforms or spectra becomes minimal or is reduced to below a selected value,
means for outputting and/or storing at least a portion of the set of elastic or geometrical borehole-formation parameters.

11. The system of claim 10 further comprising means for adjusting acoustic tool properties according to logging conditions.

12. The system of claim 10 further comprising means for optimizing processing software parameters to improve the quality of the results.
